(19) United States
(12) Patent Application Publication
(10) Pub. No.: US 2008/0250697 A1
(43) Pub. Date: Oct. 16, 2008

(54) LIVE BAIT BUCKET AND METHODS OF USE

(76) Inventor: Steven M. Wasnick, Minneapolis, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/733,844

(22) Filed: Apr. 11, 2007

(51) Int. Cl. A01K 97/05

(52) U.S. Cl. 43/56

(57) ABSTRACT

An improved bait bucket system for water and bait is provided in which bait can easily be emptied. The bucket includes a drainage door that has an open configuration and a closed configuration. When the drainage door is in its open configuration, water and bait inside the bucket system can be poured out through the drainage door without having to turn the bucket system fully upside down. When the drainage door is in its closed configuration, it preferably is substantially impermeable to passage of bait therethrough. The interior configuration of the bucket system can optionally provide a funneling effect that facilitates pouring bait and water from inside the bucket system out through the drainage door without such bait getting stuck behind any catch surface adjacent to the drainage door.

### FIELD OF THE INVENTION

The invention relates to a bucket system. In particular, the invention relates to a bucket system for holding live bait, e.g., for fishing.

### BACKGROUND OF THE INVENTION

Fishermen often use buckets for holding live bait, such as minnows, leaches, etc. Periodically, fishermen remove bait from their buckets. This is commonly done by reaching through an access opening near the top of the bucket, then grabbing (Optionally using a small net or the like) and removing a minnow, leach, etc. from inside the bucket. When buckets filled with water and live bait are carried by hand, transported in cars, or otherwise moved from place to place, the bumping and movement experienced by the bucket can cause water to splash out from the top of the bucket. As a result, some live bait buckets have a flange around their access opening to prevent water from splashing out of the bucket.

FIGS. 1 and 1A depict one type of conventional live bait bucket. Here, the lid of the bucket has a central portion 38 that can be opened and closed. The lid also has an outer portion 30, which serves as the splash-prevention flange. When it is desired to empty water and bait from a bucket of this nature, the central lid portion 38 is opened and the bucket is turned upside down. While water can be easily removed this way, bait tends not to be so easily poured out. Commonly, some of the bait gets stuck behind the splash-prevention flange 30. Bait stuck behind this flange can easily go unnoticed, eventually rotting and creating a foul stench. Fishermen may only realize that some remaining bait is stuck behind the flange once they smell the unpleasant odor. By that time, the decomposed bait may be stubbornly stuck to the bucket. It may then be necessary to disassemble the bucket (disassembly may be somewhat difficult depending upon the construction of the bucket) and manually scrape away the decomposed bait.

As an alternative method for empting a bucket of the type shown in FIGS. 1 and 1A, it may be possible to remove the entire lid from the bucket prior to dumping out the bucket. Due to the construction of many bait buckets, however, the bucket may need to be completely disassembled before the lid can be removed. Unfortunately, it may be difficult and time consuming to disassemble such a bucket. Even if the lid could be easily removed, the bucket would need to be turned upside down to be emptied. Bait buckets are heavy and awkward when filled with water and bait. Therefore, it can be difficult for a person to turn a filled bucket upside down, e.g., without spilling water and bait on him or herself. This may be especially problematic for small children, people of advanced age, or others who lack the physical strength to tip a filled bait bucket in a controlled fashion.

It would be desirable to provide a bait bucket that facilitates easy removal of bait from the bucket. It would be particularly desirable to provide a bait bucket that can be emptied without having to turn the bucket upside down.

### DESCRIPTION OF THE DRAWING

FIG. 1 is a front view of a prior art bait bucket;

FIG. 1A is a perspective view of a prior art bait bucket;

FIG. 2 is a partially exploded front view a bucket system in accordance with an embodiment of the invention;

FIG. 2A is a perspective view of a bucket system in accordance with another embodiment of the invention;

FIG. 3 is a schematic cut-out view detailing the interior of a bucket system filled with water and live bait in accordance with certain embodiments of the invention;

FIG. 4 is a front view of a bucket system in accordance with another embodiment of the invention;

FIG. 5 is a partially exploded perspective view of a bucket system in accordance with still another embodiment of the invention;

FIG. 6 is a partially exploded perspective view detailing the drainage port on the bottom of a bucket system in accordance with certain embodiments of the invention;

FIG. 7 is a perspective view detailing the drainage port on the bottom of a bucket system in accordance with certain embodiments of the invention;

FIG. 8 is a cross-sectional side view of a prior art bait trap;

FIG. 9 is a cross-sectional side view of another prior art bait trap;

FIG. 10 is a cross-sectional side view of still another prior art bait trap;

FIG. 11 is a partially broken-away cross-sectional side view of a bottom section of a bucket system in accordance with certain embodiments of the invention;

FIG. 12 is a partially broken-away cross-sectional side view of a bottom section of another bucket system in accordance with certain embodiments of the invention; and

FIG. 13 is a broken-away cross-sectional side view detailing a drainage door on a convex wall section of a bucket system in accordance with other embodiments of the invention.

### SUMMARY OF THE INVENTION

A bucket system for holding water and bait is provided. The bucket system can be emptied easily. In some embodiments, the bucket system has an assembled configuration in which at least a lower section of the bucket system is impermeable or substantially impermeable to water. The bucket system has a top end region and a bottom end region. The bucket system preferably includes a rigid sidewall bounding the interior of the bucket.

A handle can optionally be provided adjacent the bucket's top end region. The top end region has an openable and closeable access port through which a person can reach a hand into an interior of the bucket system so as to remove bait from the interior. The top end region of the bucket system may include a splash-prevention flange adjacent the access port. When provided, this flange is adapted to reduce splashing of water and bait from the bucket system, however, it also creates a catch behind which bait may be inadvertently retained upon tipping the bucket system to pour water and bait from the interior out through the access port. In some cases, the access port is in a top wall (e.g., a lid) of the bucket. The top wall of the bucket, for example, can be formed by a lid having a central portion and a peripheral portion, wherein the access port is surrounded by the peripheral portion and the central portion is an openable and closeable access door.

A drainage port is provided on a bottom end or sidewall of the bucket system. The drainage port has an open configuration and a closed configuration. When the drainage port is in its open configuration, water and bait inside the bucket system can be poured out through the drainage port, preferably without having to turn the bucket system upside down (i.e., entirely upside down). When the drainage door is in its closed configuration, it preferably is impermeable, or substantially impermeable, to passage of bait therethrough. The drainage door can be a pivotable door, a rotatable door, or another door type.

The bottom end region of the bucket system preferably is configured so as to form a stable base upon which the bucket system can be rested when filled with water and bait. In some cases, the drainage port is provided in the bottom end of the bucket. In such cases, an adjacent drainage door may form at least part of the bucket's stable base, e.g., by providing a flat surface upon which the bucket system can be stably rested when filled with water and bait.

The interior configuration of the bucket system optionally provides a funneling effect that facilitates pouring bait and water from inside the bucket system out through the drainage port without such bait getting stuck behind any catch surface adjacent the drainage door.

Certain embodiments of the invention provide a bucket system for holding water and live bait. The bucket system has an operatively assembled configuration in which at least a lower section of the bucket system is impermeable or substantially impermeable to water. The bucket system has a top end region and a bottom end. Preferably, the bucket system has a handle adjacent the top end region. The top end region has an openable and closeable access port through which a person can reach a hand into an interior of the bucket system so as to remove bait from the interior. The bottom end of the bucket system preferably is configured so as to form a stable base upon which the bucket system can be rested when filled with water and bait. Further, the bucket system preferably comprises a sidewall (optionally a rigid sidewall) bounding the interior. The bucket system has a drainage port located in either the bottom end or the sidewall. The drainage port has an open configuration and a closed configuration. When the drainage port is in its open configuration, water and bait inside the bucket system can be poured out through the drainage port without having to turn the bucket system fully upside down. Further, the drainage port when in its closed configuration is impermeable or substantially impermeable to passage of bait therethrough.

In certain embodiments, the invention provides a bucket system that is filled with water and live bait. The bucket system is in an operatively assembled configuration, and has at least a lower section that is impermeable or substantially impermeable to water. The bucket system has a top end region and a bottom end. The top end region has an access port with open and closed configurations. When the access port is in its open configuration, a person can reach a hand through the access port and into an interior of the bucket system so as to remove bait from the interior. In the present embodiments, the top end region of the bucket system includes a splash-prevention flange adjacent to the access port. This flange is adapted to reduce splashing of water and bait from the bucket system, but creates a catch behind which bait can be inadvertently retained upon tipping the bucket system to pour water and bait from the interior out through the access port. The bottom end of the bucket system is configured so as to form a stable base upon which the bucket system can be rested. The bucket system comprises a sidewall bounding the interior. The bucket system has a drainage port located in either the bottom end or the sidewall. The drainage port has open and closed configurations. When the drainage port is in its open configuration, water and bait inside the bucket system can be poured out through the drainage port without having to turn the bucket system fully upside down. Further, the drainage port when in its closed configuration is impermeable or substantially impermeable to passage of bait therethrough.

Certain embodiments provide a method for emptying bait and water from a live bait bucket system. The method comprises providing the bucket system. In the present embodiments, the bucket system is in an operatively assembled configuration, and has at least a lower section that is impermeable or substantially impermeable to water. The bucket system has a top end region and a bottom end. The top end region has an access port with open and closed configurations. When the access port is in its open configuration, a person can reach a hand through the access port and into an interior of the bucket system so as to remove bait from the interior. In the present embodiments, the top end region of the bucket system includes a splash-prevention flange adjacent to the access port. This flange is adapted to reduce splashing of water and bait from the bucket system, but creates a catch behind which bait can be inadvertently retained upon tipping the bucket system to pour water and bait from the interior out through the access port. The bottom end of the bucket system is configured so as to form a stable base upon which the bucket system can be rested. The bucket system comprises a sidewall (optionally a rigid sidewall) bounding the interior. The bucket system has a drainage port located in either the bottom end or the sidewall. The drainage port has open and closed configurations. When the drainage port is in its open configuration, water and bait inside the bucket system can be poured out through the drainage port without having to turn the bucket system fully upside down. Further, the drainage port when in its closed configuration is impermeable or substantially impermeable to passage of bait therethrough. In the present method, the drainage port is initially in its closed configuration, and the method involves switching the drainage port from its closed configuration to its open configuration, and pouring water and bait from inside the bucket system out through the drainage port without turning the bucket system fully upside down.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

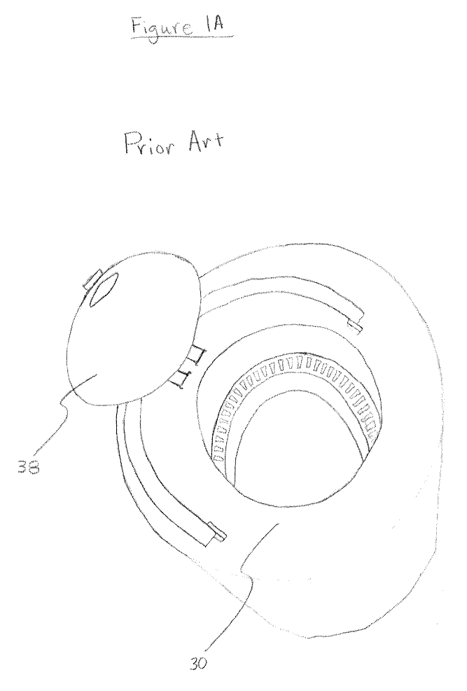

FIG. 2 illustrates a bucket system 100 in accordance with certain embodiments of the present invention. Here, the bucket system 100 includes an interior bucket 120 and an exterior bucket 150. The interior bucket 120 is adapted to be nested removably within the exterior bucket 150. A bucket system of this nature is referred to herein as a “double-bucket system” or a “double-bucket design”. When the interior and exterior buckets are operatively assembled (i.e., nested one within the other), the bucket system is adapted to hold water, preferably such that the bucket system is impermeable or substantially impermeable to water other than at openings in the top end region of the bucket system (e.g., it may be the case that at least the bottom half of the operatively assembled bucket system is impermeable to water and air while a top end region has openings sized to pass water and air). In other embodiments, the bucket system has only one bucket.

Generally, it is desirable to provide at least one handle adjacent to the top end of the bucket system. In double-bucket designs, both buckets 120, 150 preferably have handles. For example, a handle 62 can be provided on the exterior (or “outer”) bucket 150 to allow a person to conveniently carry the operatively assembled bucket system 100. Thus, when the interior bucket is nested within the exterior bucket (and when this operatively assembled bucket system is filled with water and bait), a person can carry the bucket system by a single handle 62 without having either bucket 120, 150 fall from the bucket assembly. Another handle 132 can be provided on the interior (or “inner”) bucket 120 to allow a person to easily separate the interior bucket 120 from the exterior bucket 150.

The interior bucket 120 includes a sidewall 122 that bounds an interior (e.g., a space adapted to receive water and live bait) of the bucket. In the illustrated embodiments, the sidewall 122 has a generally cylindrical configuration, although different configurations can be used. The sidewall can comprise plastic or any other suitable material. (If desired, the whole bucket can consist, or consist essentially of, plastic.) The sidewall preferably is rigid (it may be possible to bend/deflect the sidewall somewhat by pushing on it, but it preferably is not flexible enough to be wound at room temperature). All the walls of the bucket system can optionally comprise plastic and/or be rigid.

In FIG. 2, the bucket 120 includes a top end 121, a top end region 124, a bottom end 127, and a bottom end region 126. The illustrated bucket 120 has a larger diameter at its top end region 124 than at its bottom end region 126. Thus, the illustrated sidewall 122 has a tapered generally cylindrical configuration.

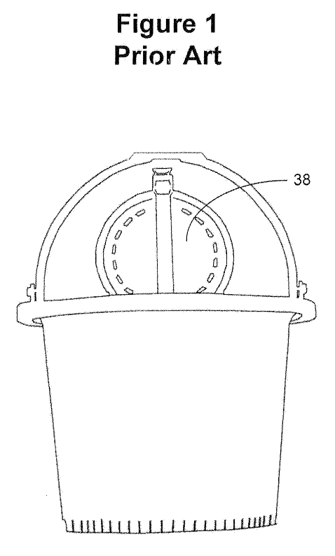

In FIG. 2, the bucket 120 also has a plurality of water passages (e.g., slits) 99. Preferably, these water passages 99 are in the bottom end region 126 of the bucket 120. In FIG. 2, the water passages 99 are provided at locations extending entirely around the bucket. Thus, the passages 99 here are formed in a wall section that forms a 360° perimeter, although this is not required in other embodiments. When provided, the water passages 99 preferably each have a major dimension of less than 2 inches, less than 1.5 inches, or less than 1.25 inches. In the illustrated design, the passages 99 are slits each having a length of about one inch and a width of between about 1/16 inch and about ¼ inch. The water passages 99 shown in FIG. 2 are formed in a wall that is generally perpendicular to the base and/or lid of the bucket 120. Alternatively, such water passages can be formed in a wall generally parallel to the bucket's lid and/or base. A wall of this nature is shown in FIG. 1A, where the optional water passages are slits adapted to pass water in a downward vertical direction. The water passages 99 may be omitted in other embodiments.

Referring to FIG. 2, the top end region 124 of the interior bucket 120 includes an openable and closeable access door 128. Here, the access door 128 is actually on the top end 121 of the bucket 120. The illustrated access door 128 is pivotally attached to a top wall (or “lid”) 133 of the bucket 120. Preferably, the access door 128 forms a central portion of the bucket's lid 133. The lid 133 is attached (optionally removably) to the sidewall 122 of the bucket 120. The access door 128 can alternatively be provided on other areas of the bucket 120, as long as the location of the door 128 is such that a person can conveniently open this door and reach inside the bucket to remove bait. Thus, when the access door is open, it exposes an access port AP through which a person preferably can reach a hand (and/or a small net) to remove bait from inside the bucket system. The access port AP in FIG. 2A has a circular or generally circular shape, although this is by no means required.

In FIG. 2A, it can be seen that the bucket 120 includes a splash-prevention flange 130 adjacent to the access port AP. Here, the splash-prevention flange 130 forms a peripheral portion of bucket's lid 133, and the access door 128 forms a central portion of the lid. In this design, the splash-prevention flange 130 surrounds the access port AP by 360°, although this is not required in other embodiments. The flange 130 is adapted to reduce splashing of water out of the bucket 120. If desired, the flange 130 can be integral to the bucket's sidewall 122. Preferably, though, the flange (and the top lid in general) is removably attachable to the sidewall.

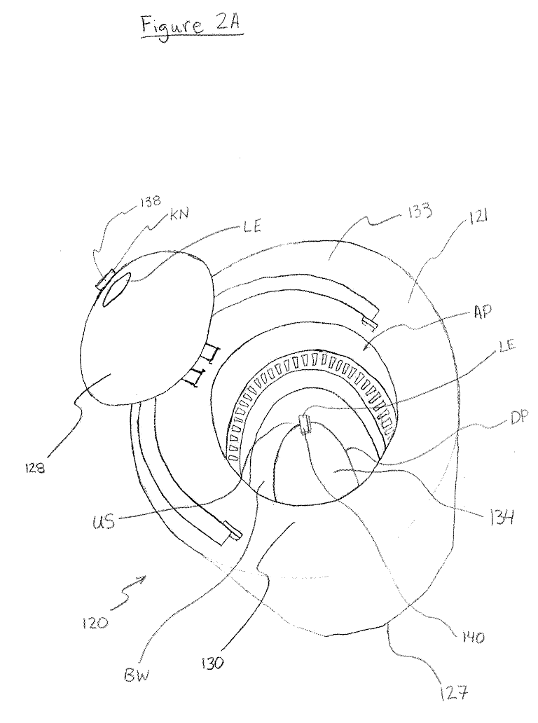

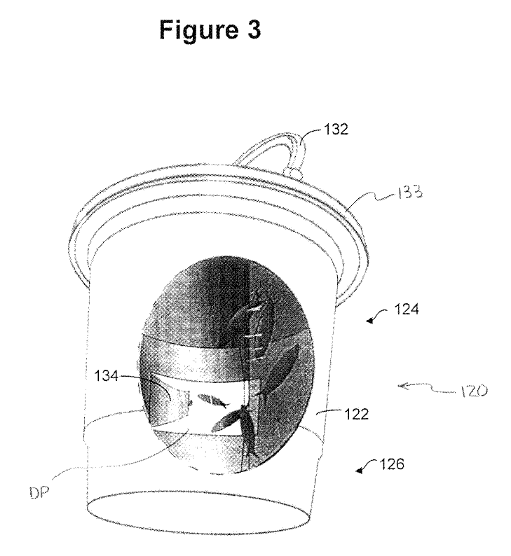

Thus, the top end region 124 of the interior bucket 120 has an access port AP through which a person preferably can reach a hand into the bucket's interior so as to remove bait from the bucket. More generally, the access port AP of the bucket system can take the form exemplified in FIGS. 2 and 2A, the form exemplified in FIGS. 4 and 5, or various other forms.

Similarly, the access door can be provided in various different forms. In some cases, the access door is a pivotable door mounted on the bucket by one or more hinges. In such cases, the pivotable door can optionally include a locking mechanism (e.g., a lock) adapted to lock the door in a closed configuration. In FIG. 2, the access door 128 includes a lock 138. Here, the lock can be an outwardly biased pinching lock, such that the lock would be pinched to unlock the door. Alternatively, the lock can comprise a rotatable knob that is externally accessible when the door 128 is closed. Reference is made to FIG. 2A. Here, the knob KN is connected (or is integral) to a lever LE, which (when the door 128 is closed) can be moved beneath the splash-prevention flange 130 by rotating the knob KN to a desired orientation. Many other types of locks can be used. Moreover, in certain embodiments, the lock is omitted.

In some cases, the access door is a pivotable door that is resiliently biased toward a closed configuration. In such cases, a person would apply force on the door to open it (e.g., by pushing it inwardly generally toward the bucket's interior). Once this force is removed, the door would move back to its closed configuration. Embodiments of this nature may, for example, be desirable for single-bucket designs like those of FIGS. 4 and 5. In alternate embodiments, the access door may be a rotatable door. For example, the splash-prevention flange on a two-bucket system like that of FIGS. 2 and 2A can have a threaded structure (not shown) and the access door can be adapted for being screwed onto the flange.

In connection with the exterior bucket 150 of a two-bucket design, this bucket 150 preferably has a bottom end region 156 with a bottom end (e.g., a bottom surface or bottom surfaces, optionally defined by one or more base rims) 152 that is at least generally planar (e.g., has at least one generally planar base surface) and/or serves as a stable base upon which the bucket system can rest when filled with water and live bait. The exterior bucket 150 preferably is sized and shaped such that the interior bucket 120 can be nested snuggly inside the exterior bucket 150.

The interior bucket 120 may also have a stable bottom end 127 with a bottom surface 142 that is at least generally planar and/or serves as a stable base upon which the bucket can rest when filled with water and bait. This makes it possible to stably rest the interior bucket 120 on its base at such times as the interior 120 and exterior 150 buckets are separated.

In the present invention, the bucket system is provided with a drainage port DP. The drainage port DP preferably has both an open configuration and a closed configuration. When the drainage port is in its open configuration, water and bait inside the bucket system can be poured out (optionally, the bucket's entire contents, or at least substantially the entire contents, of water and bait can be poured out) through the drainage port, preferably without having to turn the bucket system upside down (i.e., in a fully inverted orientation). Thus, the drainage port desirably is located in either the bottom end or a sidewall of the bucket system. The drainage port is sized to allow bait inside the bucket to be poured out through this port. When the drainage port is in its closed configuration, bait inside the bucket system preferably is prevented from escaping the bucket system through this port. Thus, the drainage port when closed preferably is impermeable or substantially impermeable to passage of bait (and in some cases, to the passage of water) therethrough.

Preferably, a drainage door is provided on a bucket of the bucket system. The drainage door desirably is openable and closeable. In FIG. 2, the drainage door 134 is about halfway up the sidewall 122 of the interior bucket 120. However, the drainage door 134 can alternatively be further toward the bucket's bottom end 127, or further toward the bucket's top end 121, as desired. As another alternative, the drainage door can be on the bottom end of a bucket system. Reference is made to FIGS. 2A, 5, 6, 7, 11, and 12.

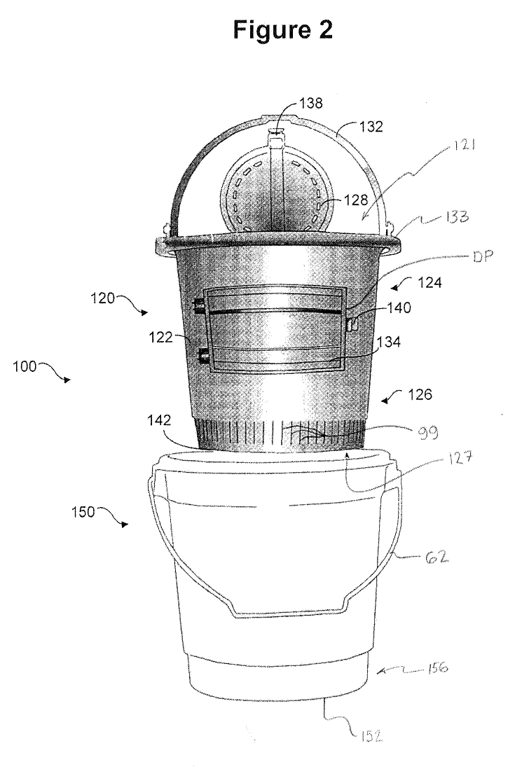

When the drainage door is open, water and bait inside the bucket system can be poured out through the adjacent drainage port DP. FIG. 3 schematically illustrates the interior bucket 120 of FIG. 2, with the drainage door 134 in an open configuration. In this configuration, water and bait inside the bucket 120 can be poured out through the drainage port DP without having to turn the bucket 120 upside down.

The drainage door can be provided in various different forms. For example, it can be a pivotable door. Reference is made to FIGS. 2, 2A, 3, 4, 11,12, and 13. Alternatively, it can be a door that is opened and closed by rotating it relative to the rest of the bucket system. Reference is made to FIGS. 5, 6, and 7. Thus, the drainage door 134 can be secured to the bucket 120 in different ways.

The drainage door can optionally be provided with a lock. Reference is made to FIG. 2. Here, the lock 140 can be a pinching lock, which would be pinched to unlock the door. Alternatively, the lock can have a lever LE that can be moved (e.g., in response to manually rotating a knob KN projecting from the bottom end 127 of the bucket 120) so as to latch on an upper surface US of a bottom wall BW of the bucket's bottom end 127. Reference is made to FIGS. 2A, 11, and 12.

FIG. 4 illustrates a bucket system 200 in accordance with another embodiment. Here, the bucket system has a double-bucket design. This bucket has a sidewall 222 bounding an interior in which water and live bait can be held. The bucket has a top end 221, a top end region 224, a bottom end 242, and a bottom end region 226. In this embodiment, an access door 228 is provided on the top end region 224 of the bucket. This particular access door has a plurality of air passages (as may be the case with the access door for any embodiment of the present invention). In FIG. 4, an upper wall section 230 adjacent to the access door 228 forms a splash-prevention flange. The bottom end region 226 of the bucket defines the bucket's bottom end 242, which preferably has a planar bottom surface and/or serves as a stable base upon which the bucket can be rested when filled with water and live bait.

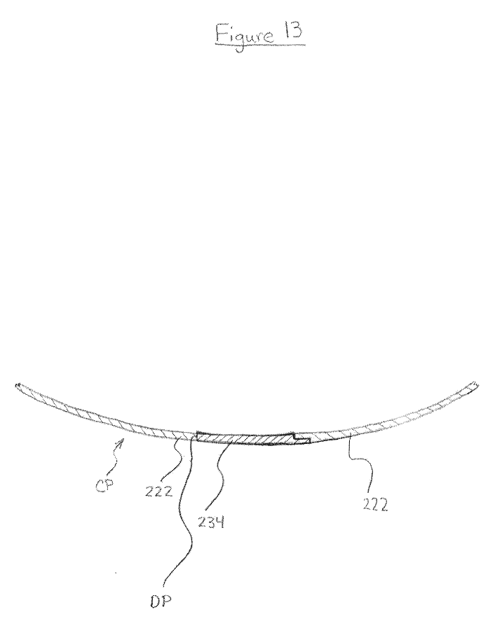

The bucket system of FIG. 4 has a drainage port DP. The drainage port DP has open and closed configurations. When this port is in its open configuration, water and bait inside the bucket system can be poured out through the drainage port, preferably without having to turn the bucket system upside down. Here, the drainage port DP is located in a sidewall 222 of the bucket system. In this particular design, the drainage port DP is located in a convex portion CP of the sidewall 222 (on the bucket's bottom end region 226). This is perhaps best appreciated by referring to FIG. 13.

Thus, a drainage door 234 preferably is provided on the bucket's bottom end region 226. In FIG. 4, the drainage door 234 is a pivotable door with a lock 240. In this embodiment, the door 234 preferably is impermeable or substantially impermeable to bait and water. The drainage door 234 in FIG. 4 has a convex configuration, although this is not required in other embodiments. The illustrated drainage door 234 is adapted to pivot about an axis that is at least generally perpendicular to the base (e.g., to a planar bottom surface) of the bucket system.

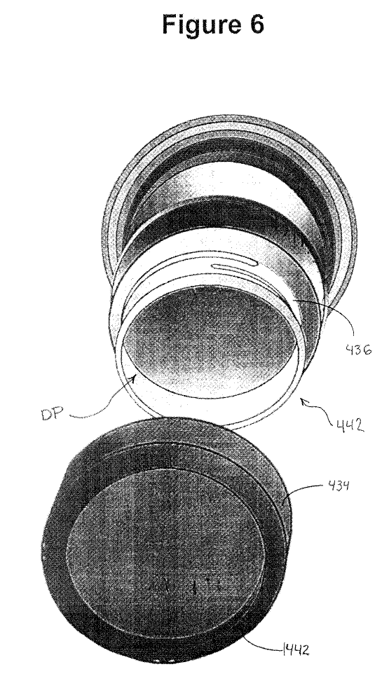

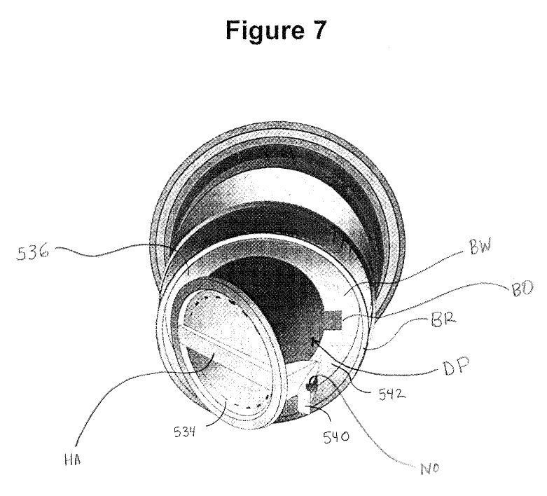

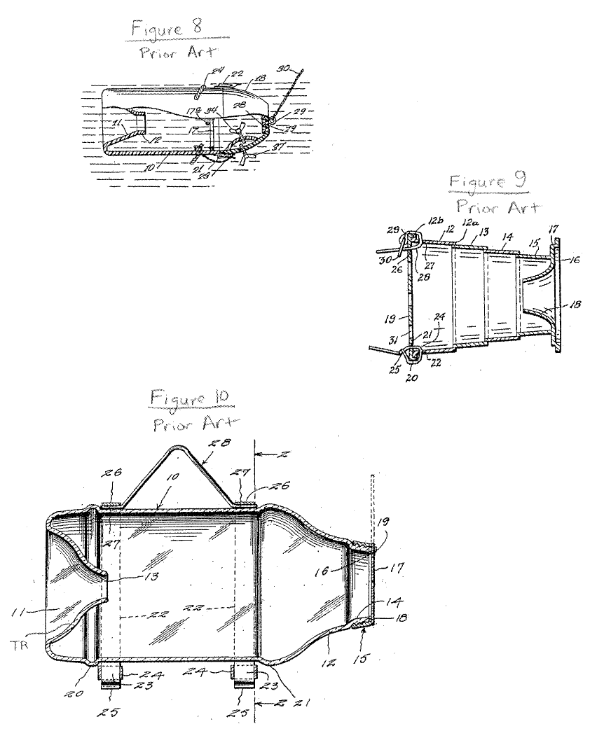

Preferably, the bucket system is devoid of any catch structure adjacent to the drainage port DP. FIGS. 8-10 depict prior art bait traps that have catch structures (element 11 in FIG. 8, element 18 in FIG. 9, and element TR in FIG. 10), which would prevent bait from being easily poured out through the adjacent openings. This is not surprising since these prior art structures are designed to be used as minnow traps. In contrast to such prior art structures, the present bucket system desirably is devoid of any catch structure that would trap bait if a person were to attempt pouring the contents of the bucket system out through the drainage port DP. Thus, the bucket system desirably does not have any generally cone-shaped structure projecting inwardly (i.e., toward an interior of the bucket system) from a bottom wall or sidewall of the bucket system (or at least the bucket system has no such structure surrounding the drainage port DP).

In some embodiments, the bucket 120 is configured to provide a funneling effect that facilitates pouring bait and water from inside the bucket system out through the drainage port without bait getting stuck inside the bucket (e.g., behind any catch structure adjacent to the drainage port). In more detail, the bucket system can optionally have an interior configuration that funnels water and live bait toward (or at least generally toward) the drainage port (at least when the bucket system is oriented with the drainage port facing generally downwardly, i.e., when the bucket system is emptied). This funneling configuration facilitates pouring bait out through the drainage port without the bait getting stuck behind any structure adjacent to the drainage port.

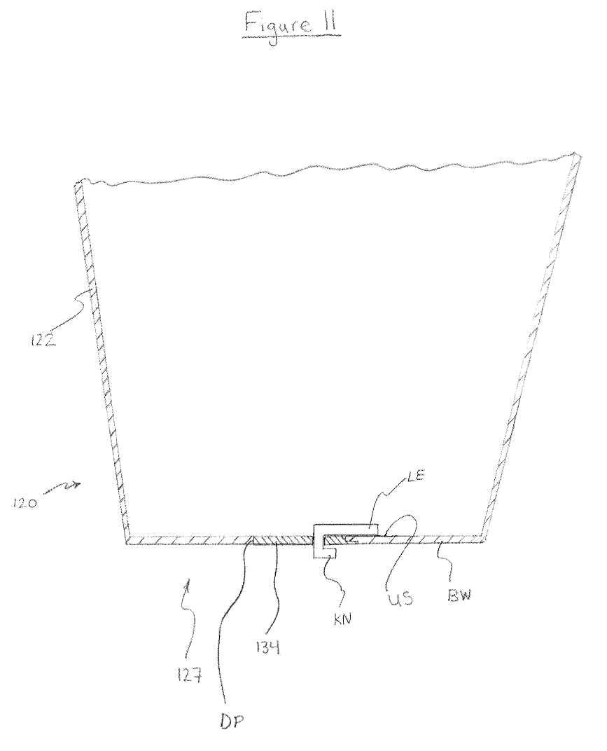

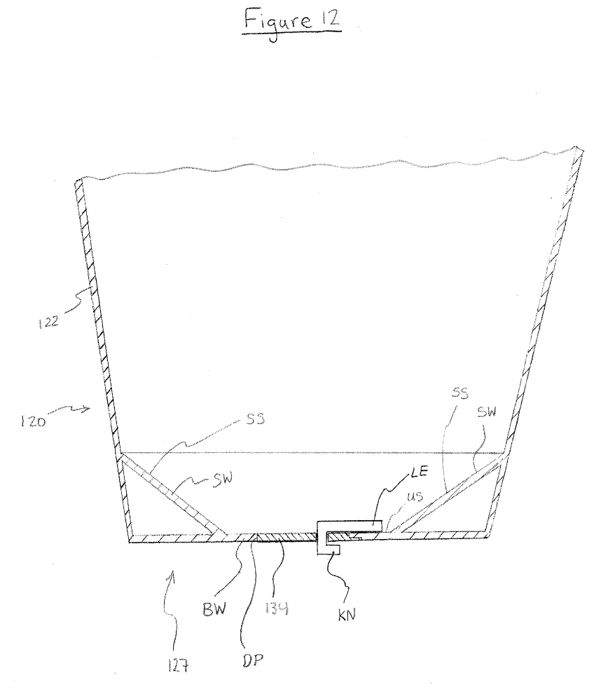

FIGS. 11-13 detail three useful funneling configurations. In FIG. 11, the sidewall 122 of the bucket 120 has a tapered configuration that provides the funneling effect. In FIG. 12, the sidewall 122 has a tapered configuration, and the bucket 120 has sloped wall sections SW that extend from the sidewall 122 to the bottom wall BW (and direct flow generally toward the drainage port). Here, the sloped wall section SW (or at least a sloped surface SS thereof) is at an angle of between about 20° and 60° relative to the bottom wall BW of the bucket 120. If desired, the wall section SW can have a curved shape, rather than extending at a substantially straight angle. In FIG. 13, the funneling effect is provided by the convex shape of the convex portion CP of the sidewall 222 in which the drainage port DP is located.

FIG. 5 illustrates a bucket system 300 in accordance with another embodiment. Here, the bucket system is similar to that of FIG. 4 in that it has a single-bucket design. In more detail, the bucket of FIG. 5 has a sidewall 322, a top end 321, a top end region 324, a bottom end 342, a bottom end region 326, an access door 328, an access port AP, a drainage door 334, and a drainage port DP. The sidewall 322 bounds the interior of the bucket. The access door 328 is on the bucket's top end region 324. This bucket system 300, however, has a drainage door 334 at the bottom end 342 of the bucket. Here, the bottom end 342 of the bucket has a rim (or “collar”) 336 that is adapted to removably receive a cap 334 that serves both as the drainage door and the bucket's stable base. This cap 334 can be attached removably to the bottom end 342 (e.g., to a rim or collar 336 thereof) of the bucket, for example, by virtue of a threaded connection.

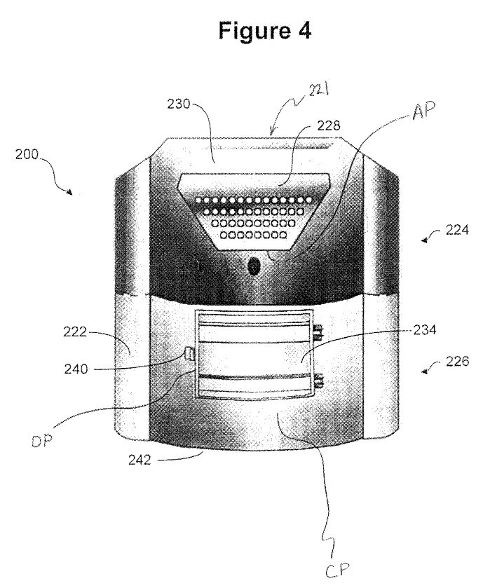

FIG. 6 details one type of threaded drainage door 434 that can be used (the buckets of FIGS. 5 and 6 have different designs, however they both can be used with the same type of removable threaded drainage door). Here, a threaded structure (e.g., an exteriorly threaded rim, “collar”, or other male portion) 436 is provided on the bottom end 442 of the bucket, and the drainage door 434 has a corresponding threaded portion (e.g., an interiorly threaded female portion) that can be screwed onto threaded structure 436. The male and female arrangement can alternatively be revered (i.e., an exteriorly threaded male structure can be on the door 434 and an interiorly threaded structure can be on the bucket's bottom end). The illustrated door (or “cap”) 434 has a planar base surface 1442 that forms a stable base upon which the bucket can be rested.

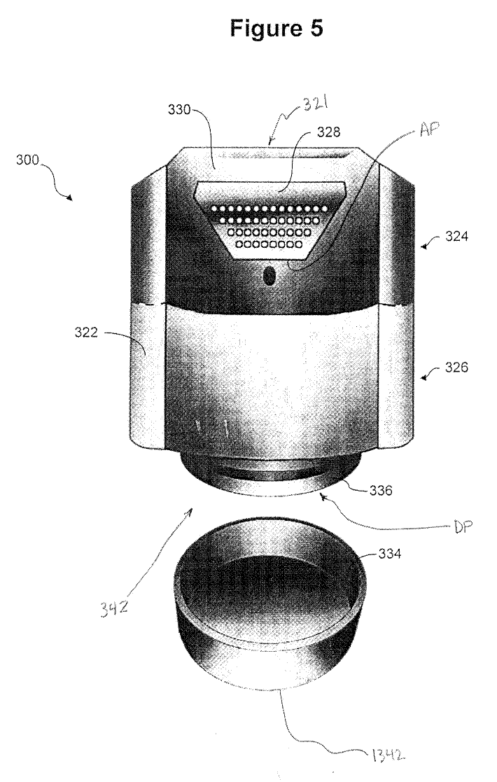

FIG. 7 illustrates another embodiment wherein the drainage port DP is on the bottom end of a bucket. Here, the bucket has another type of drainage door 534 that can be removably attached (like those in FIGS. 5 and 6) to the bottom end 542 of the bucket. This drainage door 534 is provided with a detent 540 that can be attached removably to the bucket's bottom wall BW. In more detail, the bottom wall BW of the bucket here has a cut-out or other opening BO through which the detent 540 can pass when the door 534 is in the proper rotational orientation. Though not seen in FIG. 7, the door 534 preferably has two diametrically-opposed detents 540, and the bucket's bottom wall BW preferably has two corresponding openings BO. Thus, to assemble this door 534 on the bottom end 542 of the bucket, one would align the detents 540 with the openings BO, and then push the door toward the bucket's interior until the notches NO in the detents 540 are aligned with the bucket's bottom wall BW. At this point, the door 534 is rotated (optionally using a handle HA on the door) relative to the rest of the bucket, causing the detents 540 to interlock with the bucket's bottom wall BW. The door 534 is then in its closed configuration. The door 534 can subsequently be opened and removed from the bucket by rotating the door back to the orientation in which its detents 540 are aligned with the openings BO in the bucket's bottom wall BW, at which point the door 534 can be separated from the rest of the bucket by simply pulling the door directly away from the bottom of the bucket. In the embodiment of FIG. 7, the bottom end of the bucket has a bottom rim BR, which provides the bucket with a stable base.

While preferred embodiments of the invention have been described, it should be understood that numerous changes, adaptations, and modifications can be made therein without departing from the spirit of the invention and the scope of the appended claims. All references mentioned in this application are incorporated by reference.

What is claimed is:

1. A bucket system for holding water and live bait, the bucket system having an operatively assembled configuration in which at least a lower section of the bucket system is impermeable or substantially impermeable to water, the bucket system having a top end region and a bottom end, the bucket system having a handle adjacent the top end region, the top end region having an openable and closeable access port through which a person can reach a hand into an interior of the bucket system so as to remove bait from said interior, the bottom end of the bucket system being configured so as to form a stable base upon which the bucket system can be rested when filled with water and bait, the bucket system comprising a sidewall bounding said interior, the bucket system having a drainage port located in either the bottom end or said sidewall, the drainage port having an open configuration and a closed configuration, wherein when the drainage port is in its open configuration water and bait inside the bucket system can be poured out through the drainage port without having to turn the bucket system fully upside down, wherein the drainage port when in its closed configuration is impermeable or substantially impermeable to passage of said bait therethrough.

2. The bucket system of claim 1 wherein the top end region of the bucket system includes a splash-prevention flange adjacent to the access port, said flange being adapted to reduce splashing of water and bait from the bucket system but creating a catch behind which bait may be inadvertently retained upon tipping the bucket system to pour water and bait from the interior out through the access port.

3. The bucket system of claim 1 wherein the bucket system has a funneling interior configuration adapted to funnel bait and water toward the drainage port when the bucket system is emptied.

4. The bucket system of claim 1 wherein the drainage port is located in a convex portion of said sidewall, and wherein a convex drainage door is mounted pivotally to said convex portion of said sidewall.

5. The bucket system of claim 4 wherein the drainage door is adapted to pivot about an axis that is at least generally perpendicular to the stable base of the bucket system.

6. The bucket system of claim 1 wherein the drainage port is located in the bottom end of the bucket system.

7. The bucket system of claim 6 wherein the drainage port is adapted for being moved between its open and closed configurations by rotating a drainage door of the bucket system.

8. The bucket system of claim 7 wherein the drainage port is adapted for being moved between its open and closed configurations by rotating the drainage door about an axis that is at least generally perpendicular to the stable base of the bucket system.

9. The bucket system of claim 7 wherein the bottom end of the bucket defines a threaded section that is adapted to threadingly receive the drainage door, wherein when the drainage door is threadingly coupled to said threaded section the drainage port is in its closed configuration and is impermeable or substantially impermeable to passage of water therethrough.

10. The bucket system of claim 2 wherein the access port is located in a top lid of the bucket system.

11. The bucket system of claim 10 wherein the top lid of the bucket system defines said splash-prevention flange, and said flange surrounds the access port.

12. The bucket system of claim 1 wherein an access door adjacent to the access port is mounted pivotally to the top lid of the bucket system.

13. The bucket system of claim 1 wherein the access door has a plurality of openings sized to pass air and water.

14. The bucket system of claim 1 comprising an interior bucket and an exterior bucket, each of said buckets having a generally cylindrical configuration, the interior bucket having top and bottom walls that are at least generally parallel to each other, the interior bucket having both the access port and the drainage port, the exterior bucket having a bottom wall but no top wall.

15. The bucket system of claim 1 wherein said sidewall is a rigid sidewall.

16. A bucket system filled with water and live bait, the bucket system being in an operatively assembled configuration and having at least a lower section that is impermeable or substantially impermeable to water, the bucket system having a top end region and a bottom end, the top end region having an access port with open and closed configurations, wherein when the access port is in its open configuration a person can reach a hand through the access port and into an interior of the bucket system so as to remove bait from said interior, the top end region of the bucket system including a splash-prevention flange adjacent to the access port, said flange being adapted to reduce splashing of water and bait from the bucket system but creating a catch behind which bait may be inadvertently retained upon tipping the bucket system to pour water and bait from the interior out through the access port, the bottom end of the bucket system being configured so as to form a stable base upon which the bucket system can be rested, the bucket system comprising a sidewall bounding said interior, the bucket system having a drainage port located in either the bottom end or said sidewall, the drainage port having open and closed configurations, wherein when the drainage port is in its open configuration water and bait inside the bucket system can be poured out through the drainage port without having to turn the bucket system fully upside down, wherein the drainage port when in its closed configuration is impermeable or substantially impermeable to passage of said bait therethrough.

17. The bucket system of claim 16 wherein the bucket system has a funneling interior configuration adapted to funnel bait and water toward the drainage port when the bucket system is emptied.

18. The bucket system of claim 16 wherein the bucket system is devoid of any catch structure adjacent to the drainage port.

19. The bucket system of claim 16 wherein the bucket system has a handle adjacent to the top end region of the bucket system.

20. A method for emptying bait and water from a live bait bucket system, the method comprising:
a) providing the bucket system, the bucket system being in an operatively assembled configuration and having at least a lower section that is impermeable or substantially impermeable to water, the bucket system having a top end region and a bottom end, the top end region having an access port with open and closed configurations, wherein when the access port is in its open configuration a person can reach a hand through the access port and into an interior of the bucket system so as to remove bait from said interior, the top end region of the bucket system including a splash-prevention flange adjacent to the access port, said flange being adapted to reduce splashing of water and bait from the bucket system but creating a catch behind which bait may be inadvertently retained upon tipping the bucket system to pour water and bait from the interior out through the access port, the bottom end of the bucket system being configured so as to form a stable base upon which the bucket system can be rested, the bucket system comprising a sidewall bounding said interior, the bucket system having a drainage port located in either the bottom end or said sidewall, the drainage port having open and closed configurations, wherein when the drainage port is in its open configuration water and bait inside the bucket system can be poured out through the drainage port without having to turn the bucket system fully upside down, wherein the drainage port when in its closed configuration is impermeable or substantially impermeable to passage of bait therethrough, the drainage port being in its closed configuration; and
b) switching the drainage port from its closed configuration to its open configuration, and pouring water and bait from inside the bucket system out through the drainage port without turning the bucket system fully upside down.

21. The bucket system of claim 20 wherein the bucket system has a funneling interior configuration that, during said pouring, funnels bait and water toward the drainage port.
